(19) United States
(12) Patent Application Publication
(10) Pub. No.: US 2006/0143659 A1
(43) Pub. Date: Jun. 29, 2006

(54) TV broadcasting receiving apparatus and receiving method thereof

(75) Inventor: Kohei Miyoshi, Fukaya-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/315,300

(22) Filed: Dec. 23, 2005

(30) Foreign Application Priority Data
Dec. 27, 2004 (JP) P2004-376886

(51) Int. Cl. H04N 5/445

(52) U.S. Cl. 725/58

(57) ABSTRACT

A TV broadcasting receiving apparatus according to the present invention includes a digital broadcasting receiving unit that receives digital TV broadcasting, a first time-extracting unit that extracts first time-information included in the digital TV broadcasting, a second time-extracting unit that extracts second time-information via an electric communication line, an electronic timer that enables the time setting, and a control unit that sets the time of the electronic timer and performs various time management based on the time of the electronic timer. When the first time-information is obtained, the control unit sets the time of the electronic timer by using the first time-information and, when the first time-information is not obtained and the second time-information is obtained, the control unit sets the time of the electronic timer by using the second time-information.

### CROSS-REFERENCE TO RELATED APPLICATIONS

This application claims the benefit of priority of Japanese Patent Application No. 2004-376886, filed Dec. 27, 2004, the entire contents of which are incorporated herein by reference.

### BACKGROUND

1. Field

The present invention relates to a TV broadcasting receiving apparatus and a receiving method thereof, and more particularly, to a TV broadcasting receiving apparatus and a receiving method thereof for reception of analog and digital broadcasting and Internet access.

2. Description of the Related Art

Recently, a terrestrial digital broadcasting has started, and digital TV broadcasting has been widespread in addition to conventional satellite digital broadcasting.

In the digital TV broadcasting, not only a digital video signal and a digital audio signal but also various pieces of digital data are broadcasted, and various services and information are provided for viewers.

The information provided by the digital TV broadcasting includes, so-called EPG (Electronic Program Guide) and TOT (Time Offset Table) information having the current time and the date information.

The EPG is different from a program guide provided by newspapers and magazines. When the TV program is suddenly changed, the changed contents are reflected to the EPG and are then distributed. The EPG is accepted by the viewers as a convenient program.

Further, the TOT is information indicating the precise time which is distributed from a broadcasting station together with the EPG. In the distribution from the broadcasting station, the TOT and the EPG are distributed at the consistent time. Therefore, the TOT and the EPG are combined, thereby accurately performing programmed recording without fail.

Recently, many electronic devices including a recent TV-broadcasting receiving apparatus comprise an electronic timer. Based on the time of the electronic timer, various time managements are performed. The time of electronic timer is manually set by a user at the start timing of using the electronic device in many cases. However, a setting error at the setting timing is not completely excluded. Further, a time error can be caused due to the elapse of time of the electronic device.

Then, a technology for precise time-management is developed by correcting time information of the built-in electronic timer by using the TOT, serving as precise time-information distributed from the broadcasting station.

For example, U.S. Patent Publication No. 2002-0101787 discloses a technology, in which a memory for properly storing the difference between the time information of the built-in electronic timer and the TOT, i.e., an error of the electronic timer is provided and, when the precise time-management is necessary, the time information is precisely obtained by using the error stored in the memory and the time of the electronic timer.

Recently, a TV broadcasting receiving apparatus for receiving various services by the Internet access is widespread. The above-mentioned TV broadcasting receiving apparatus can obtain not only the EPG of digital broadcasting but also the EPG of analog broadcasting via the Internet. Further, the time information (hereinafter, also referred to as Internet time) can simultaneously be obtained via the Internet.

The EPG and the Internet time are distributed via the Internet by ensuring the consistency. Therefore, in the programmed recording using the EPG received via the Internet, the programmed recording can precisely be performed by using the Internet time without fail.

As mentioned above, in the recent TV broadcasting receiving apparatus, three or more pieces of time information are provided in many cases, including the time information of the built-in electronic timer, the time information using the TOT distributed from the broadcasting station for digital broadcasting, and the Internet time distributed via the Internet.

However, when three or more pieces of time information are provided, the conventional TV broadcasting receiving apparatus does not have means for selecting the best time-information in accordance with the receiving environment. Here, the “best time-information” means that the time information ensures the consistency with the service, such as the distributed EPG. For example, in the case of using the EPG distributed from the digital broadcasting, the time information of the TOT included in the digital broadcasting corresponds to the “best time-information”. In the case of using the EPG distributed via the Internet, the Internet time corresponds to the “best time-information”.

Since the means for selecting the best time-information is not provided, e.g., even a TV broadcasting receiving apparatus having both a receiving function of digital TV broadcasting and an Internet access function necessarily fixedly uses only the time information provided from one of the receiving function and the Internet access function.

As a consequence, in the case of fixedly using, as the time information, the TOT of the digital TV broadcasting, when the digital TV broadcasting can not be received due to the heavy rain, the TOT also can not be received. Further, although the TV broadcasting receiving apparatus accesses the Internet, the Internet time cannot be used because of fixedly using of the TOT. As a result, the precision deteriorates, that is, the TV broadcasting receiving apparatus necessarily uses the time information of the built-in electronic timer which does not correspond to the “best time-information”.

Further, there is a problem that erroneous time-information is continuously used when the time of the built-in electronic timer is not properly set.

### SUMMARY OF THE INVENTION

The present invention is made in light of the above described circumstances, and an object of the present invention is to provide a TV broadcasting receiving apparatus and receiving method of the TV broadcasting receiving apparatus which are capable of selecting and setting time management information properly to perform a precise and secure program recording reservation, in the circumstances where plural kinds of time management information are obtained.

Accordingly, in one aspect, the present invention provides a TV broadcasting receiving apparatus including a digital broadcasting receiving unit that receives digital TV broadcasting; a first time-extracting unit that extracts first time-information included in the digital TV broadcasting; a second time-extracting unit that extracts second time-information via an electric communication line; an electronic timer that enables a time setting; and a control unit that sets a time of the electronic timer and performs various time management based on the time of the electronic timer, wherein, when the first time-information is obtained, the control unit sets the time of the electronic timer by using the first time-information and, when the first time-information is not obtained and the second time-information is obtained, the control unit sets the time of the electronic timer by using the second time-information.

According to another aspect, the present invention provides a receiving method of a TV broadcasting receiving apparatus including extracting first time-information included in digital TV broadcasting; extracting second time-information via an electric communication line; setting a time of an electronic timer built in by using the first time-information when the first time-information is obtained; setting a time of the electronic timer by using the second time-information when the first time-information is not obtained and the second time-information is obtained; and performing various time-management based on the set time of the electronic timer.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an example of the system structure of a TV broadcasting receiving apparatus according to an embodiment of the present invention;

FIG. 2 is a flowchart showing processing of a receiving method of the TV broadcasting receiving apparatus according to the embodiment of the present invention;

FIG. 3A is a diagram showing an image display example for setting the permission or prohibition of automatic time-setting of an RTC (Real Time Clock) using TOT;

FIG. 3B is a diagram showing an image display example for setting the permission or prohibition of automatic time-setting of the RTC using an Internet time; and

FIG. 4 is a diagram showing an image display example for prompting the time setting of the RTC to a user.

### DETAILED DESCRIPTION

A description is given of a TV broadcasting receiving apparatus and a receiving method thereof according to an embodiment of the present invention with reference to the drawings.

(1) Structure of TV Broadcasting Receiving Apparatus 1

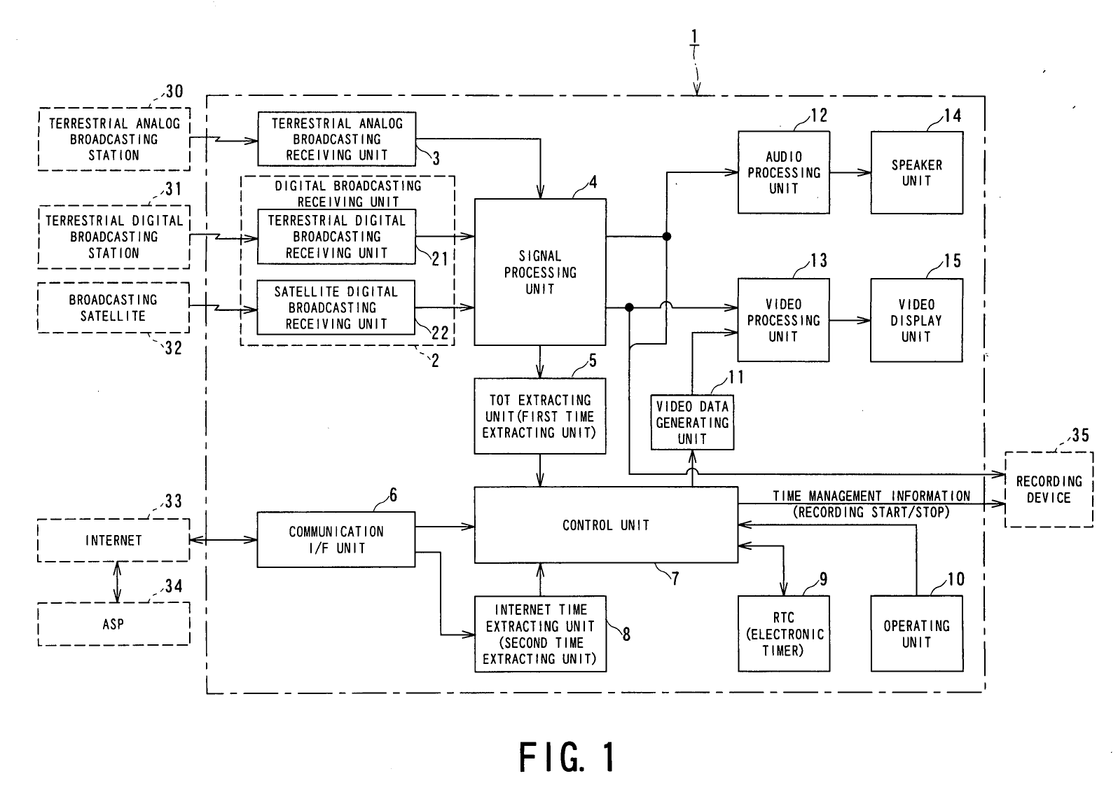

FIG. 1 is a diagram showing an example of the system structure of a TV broadcasting receiving apparatus 1 according to an embodiment of the present invention.

The TV broadcasting receiving apparatus 1 comprises: a digital broadcasting receiving unit 2 that receives broadcasting signals sent from a broadcasting satellite 32 and a terrestrial digital broadcasting station 31; and a terrestrial analog broadcasting receiving unit 3 that receives the broadcasting signal sent from a terrestrial analog broadcasting station 30. The outputs of the above-mentioned units are connected to a signal processing unit 4. The signal processing unit 4 splits the received broadcasting signal to an audio signal and a video signal. The outputs from the signal processing unit 4 are connected to an audio processing unit 12 and a video processing unit 13, respectively.

The output of the audio processing unit 12 is connected to a speaker unit 14, and the video processing unit 13 is connected to a video display unit 15 comprising a CRT or a liquid crystal display.

Another output of the signal processing unit 4 is connected to a TOT extracting unit (first time extracting unit) 5, and the output of the TOT extracting unit 5 is connected to a control unit 7.

Further, the TV broadcasting receiving apparatus 1 further comprises: a communication I/F unit 6 that communicates data with an ASP 34 via an Internet (electric communication line) 33. The output of the communication I/F unit 6 is connected to the control unit 7 and an Internet time extracting unit (second time extracting unit) 8.

An electronic timer, i.e., an RTC(Real time Clock) 9 included in the TV broadcasting receiving apparatus 1 is connected to the control unit 7. Further, an operating unit 10 comprising a remote controller or an operating panel is connected to the control unit 7. In addition, the TV broadcasting receiving apparatus 1 comprises: a video data generating unit 11 that generates video data for displaying proper information from the control unit 7 to the video display unit 15.

(2) Basic Operation of TV Broadcasting Receiving Apparatus 1

A description is given of the basic operation of the TV broadcasting receiving apparatus 1 having the above-mentioned structure.

The digital broadcasting sent from the terrestrial digital broadcasting station 31 is inputted to a terrestrial digital broadcasting receiving unit 21 via an antenna (not shown).

Similarly, satellite digital broadcasting waves sent from the broadcasting satellite 32 are inputted to the satellite digital broadcasting receiving unit 22 via an antenna (not shown).

In the terrestrial digital broadcasting receiving unit 21, a receiving signal is demodulated by a demodulator (not shown) corresponding to a modulating format of the terrestrial digital broadcasting, e.g., data string (transport stream) based on MPEG2 standard is extracted and is then outputted to the signal processing unit 4.

Similarly, in the satellite digital broadcasting receiving unit 22, a receiving signal is demodulated by a demodulator (not shown) corresponding to a modulating format of the satellite digital broadcasting, data string (transport stream) based on MPEG2 standard is extracted and is then outputted to the signal processing unit 4.

According to the embodiment, referring to FIG. 1, the digital broadcasting receiving unit 2 is configured to have both the terrestrial digital broadcasting receiving unit 21 and the satellite digital broadcasting receiving unit 22. However, the digital broadcasting receiving unit 2 may have one of both the terrestrial digital broadcasting receiving unit 21 and the satellite digital broadcasting receiving unit 22.

The data string (transport stream) inputted to the signal processing unit 4 is split into an audio signal (digital) and a video signal (digital) by an MPEG2 decoder (not shown). The audio signal is outputted to the audio processing unit 12, and the video signal is outputted to the video signal processing unit 13.

The audio processing unit 12 performs processing, such as conversion into an analog audio signal, of the input audio signal (digital) and outputs the processed signal to the speaker unit 14.

The video signal processing unit 13 superimposes character or image data generated by the video data generating unit 11 into a video signal (digital). After that, if necessity, the video signal processing unit 13 converts the video signal into an analog signal, and then outputs the analog signal to the video display unit 15 comprising a CRT or a liquid crystal display.

The terrestrial analog broadcasting receiving unit 3 receives the analog broadcasting sent from the terrestrial analog broadcasting station 30, and demodulates the receiving signal by a demodulator (not shown) corresponding to a modulating format of the terrestrial analog broadcasting. Then, the terrestrial analog broadcasting receiving unit 3 outputs the signal to the signal processing unit 4. The signal processing unit 4 converts the input analog broadcasting signal into a signal suitable for digital recording of audio data and video data by using an MPEG2 encoder (not shown). After the conversion into the signal based on the standard of MPEG2, The signal processing unit 4 outputs the signal to the audio processing unit 12 and the video processing unit 13 by the same processing as that of the digital broadcasting.

When the digital recording of audio data and video data is not necessary, the terrestrial analog broadcasting receiving unit 3 may split the signal into the audio signal and the video signal and then may output the split signals to the audio processing unit 12 and the video processing unit 13, not via the signal processing unit 4.

The signal processing unit 4 outputs, to the TOT extracting unit 5, the transport stream extracted by the digital broadcasting receiving unit 2.

The TOT extracting unit 5 extracts TOT (first time-information) from the data string of the transport stream. The TOT corresponds to the time information sent from the terrestrial digital broadcasting station 31 or the broadcasting satellite 32 at a predetermined sending time-interval, including JST (Japan Standard Time) and date information. The TOT extracted by the TOT extracting unit 5 is inputted to the control unit 7.

The communication I/F unit 6 performs the external communication via the Internet (electric communication line) 33. Many ASPs (Application Service Providers) 34 connected to the Internet 33 provide the time information via the Internet 33. The time information is referred to as Internet time (second time-information).

Further, many ASPs 34 provide the EPG of the analog broadcasting or the digital broadcasting. The ASP 34 provides not only the EPG but also the Internet time in many cases.

The ASP 34 responds to a sending request from the communication I/F unit 6, and then sends information including the EPG and the Internet time.

The Internet time extracting unit 8 extracts the Internet time from the information received by the communication I/F unit 6, and outputs the extracted data to the control unit 7.

Similarly to many recent electronic devices, the TV broadcasting receiving apparatus 1 includes a RTC (Real Time clock) 9, i.e., the electronic timer. Arbitrary time of the RTC 9 can be set by a user with the operating unit 10 and, generally, the current time of the RTC 9 is set by the user.

The TV broadcasting receiving apparatus 1 performs various time controls by using the time of the RTC 9, as time management information. For example, the power of the TV broadcasting receiving apparatus 1 is turned on/off at the time preset by the user. Alternatively, the program of a channel preset by the user starts to be recorded at the setting time.

As mentioned above, the EPG can be provided from the digital broadcasting or the ASP 34. The EPG includes information, such as the program channel, program broadcasting day, broadcasting start time, and broadcasting end time. Further, unlike the program table of newspapers and magazines, even if the program is suddenly changed, the program contents of the EPG are updated in realtime. Therefore, a desired program can be certainly recorded without missing by the programmed recording with the EPG.

However, a time management for recording the program, such as a start or end of recording, is based on the time of the RTC 9. Therefore, only when the time of the RTC 9 is precise, the precisely programmed recording can be recorded even with the EPG.

Then, the TV broadcasting receiving apparatus 1 according to the present invention, the control unit 7 can set the time of the RTC 9 by using the time information, such as the TOT or Internet time.

(3) Receiving Method of TV Broadcasting Receiving Apparatus for Setting Time by Using Control Unit

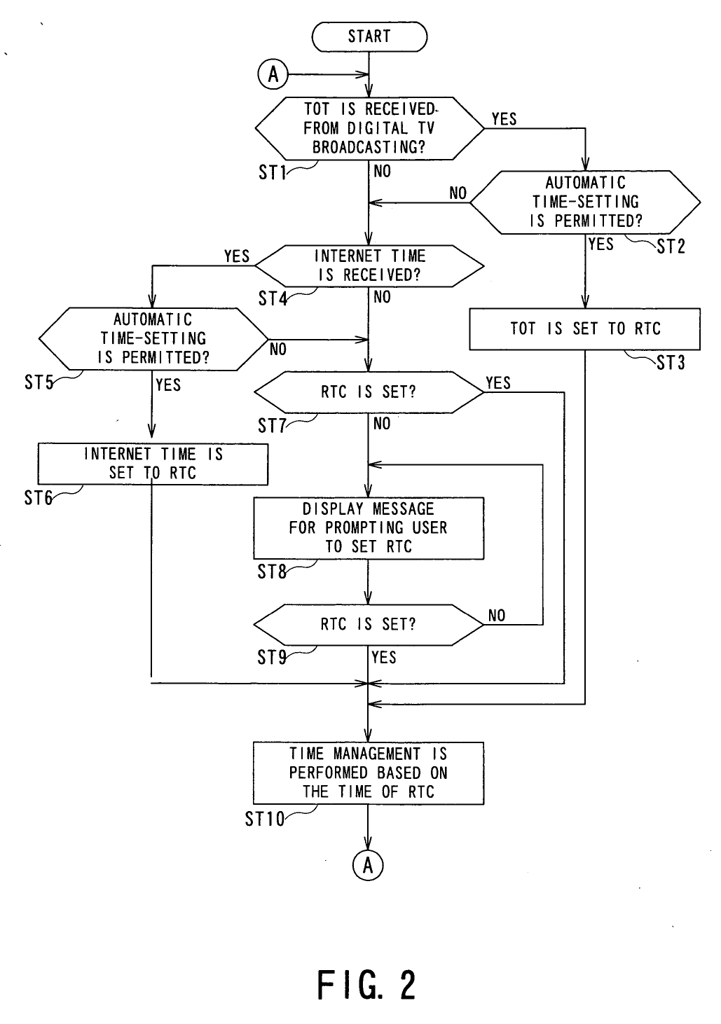

A specific description is given of the time setting of the RTC 9 by using the control unit 7 with reference to a flowchart in FIG. 2.

In step ST1, it is determined whether or not the TOT is received from the digital TV broadcasting. The terrestrial digital broadcasting or the satellite broadcast sends the TOT every predetermined period. Therefore, as the determining method, a constant margin is added for the predetermined period to set a time threshold and, when the TOT is not received for a period over the time threshold, it is determined that the TOT is not received.

When it is determined that the TOT is received from the digital TV broadcasting, the processing routine advances to step ST2.

In step ST2, it is determined whether or not automatic time-setting is permitted. The permission and prohibition of the automatic time-setting means the permission and prohibition of the automatic setting of the RTC 9 by using the TOT received from the digital TV broadcasting. The automatic time-setting is set, in advance, to the TV broadcasting receiving apparatus 1 by the user.

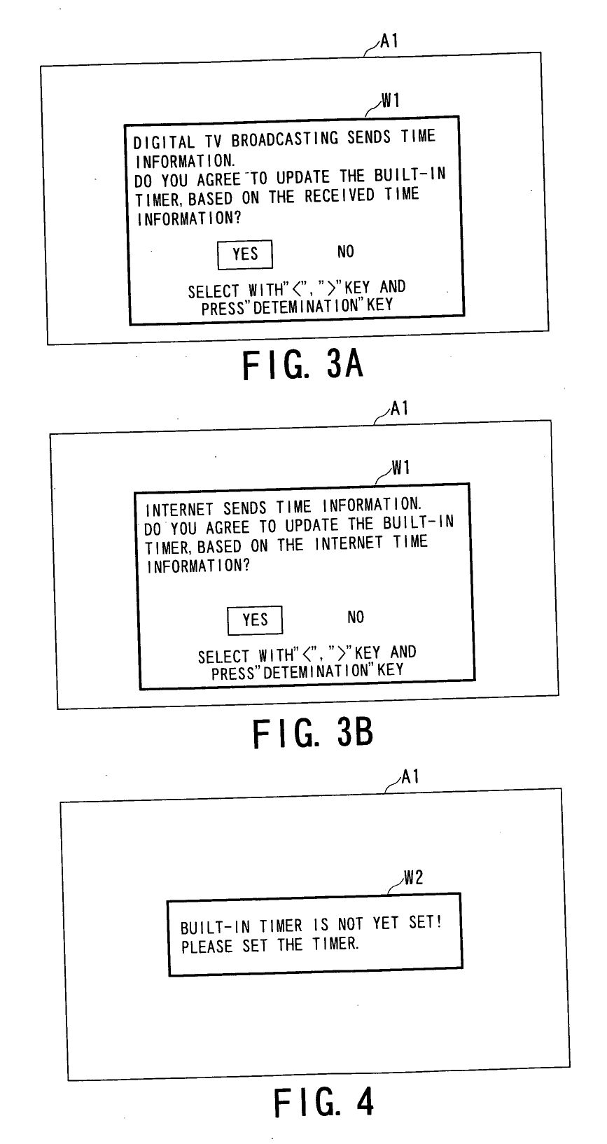

FIG. 3A is a diagram showing an image display example for setting the permission or prohibition of automatic time-setting of the RTC using a menu function of the TV broadcasting receiving apparatus 1 by the user. Referring to FIG. 3A, a character string is displayed on a display window W1 displayed in a display area A1. The user checks the contents of character string, then selects “YES” or “NO” by using the remote controller of the operating unit 10, and determines “YES” or “NO” by a determination key, thereby setting the permission or prohibition of the automatic time-setting. The setting is stored in a proper memory (not shown) of the control unit 7.

The control unit 7 refers to the contents of the memory, and when the automatic time-setting is permitted (YES in step ST2), the TOT received by the digital TV broadcasting is set to the RTC 9 (in step ST3). After that, the processing routine advances to step ST10.

In step ST10, the time is variously managed by using the time information of the RTC 9 set by the time of the TOT. As a consequence, e.g., the start time of program recording of the EPG provided from the digital TV broadcasting corresponds to the time information (TOT) provided from the same digital TV broadcasting, and this enables precise and certain program-recording.

When it is determined in step ST1 that the TOT is not received from the digital TV broadcasting, the processing routine advances to step ST4. In addition, when the automatic time-setting is not permitted, the processing routine also advances to step ST4.

The TOT is not received from the digital TV broadcasting with a case where, for example, the TV broadcasting receiving apparatus 1 originally does not have the receiving function of the digital TV broadcasting. Alternatively, in the case of a heavy rain or the like, the TOT may not be received even when the TV broadcasting receiving apparatus 1 has the receiving function of the digital TV broadcasting.

In step ST4, it is determined whether or not the Internet time is received from the ASP 34 or the like. When it is determined that the Internet time is received, in step ST5, it is determined whether or not the automatic time-setting is permitted.

Similarly to FIG. 3A, this is determined on a menu screen shown in FIG. 3B based on the contents of the permission or prohibition preset to the control unit 7 of the TV broadcasting receiving apparatus 1.

When it is determined the automatic time-setting by the Internet time is permitted, in step ST6, the Internet time is set to the RTC 9 and then the processing routine advances to step ST10.

In step ST10, the time is variously managed by using the time information of the RTC 9 set by the Internet time. As a result, the start time of program recording of the EPG provided from the ASP 34 via the Internet 33 corresponds to the time information (Internet time) provided from the same ASP 34, thereby precisely and certainly performing the program recording.

When it is determined in step ST4 that the Internet time is not received or when it is determined in step ST5 that the automatic time-setting is not permitted, the processing routine advances to step ST7.

The Internet time is not received in the case where the TV broadcasting receiving apparatus 1 originally does not have the communication function with the Internet. The Internet time is not also received when the TV broadcasting receiving apparatus 1 cannot communicate data due to some reason, even when it has the communication function with the Internet.

In step ST7, it is determined whether or not the time of the RTC 9 is set.

The time is not set to the RTC 9 (NO in step ST7) in the case in which the TOT and the Internet time have not been received (including the case in which the receiving functions of the TOT and the Internet time are not provided). Alternatively, the time is not also set to the RTC 9 in the case in which the automatic time-setting by the TOT and the Internet time is prohibited and the user never have set the time of the RTC 9.

In such a case, in order to manage the time by the TV broadcasting receiving apparatus 1, the user has to necessarily set the time of the RTC 9.

Then, in step ST8, in order to set the time of the RTC 9 by the user, the indication prompting the time setting is performed on the video display unit 15.

FIG. 4 shows a display example for prompting the time setting. The user reads the display contents of a display window W2 displayed in the display area A1. Thus, when the user omits or forgets the time setting of the RTC 9, the user's awareness is promoted, thereby setting the time of the RTC 9 by the user. The TV broadcasting receiving apparatus 1 can manage the time.

In step ST9, it is determined whether or not the time of the RTC 9 is set. When it is determined in step ST9 that the time of the RTC 9 is not set, the indication promoting the time setting continues until the time is set. On the other hand, when it is determined in step ST9 that the time of the RTC 9 is set, the processing routine advances to step ST10.

When it is determined in step ST7 that the time of the RTC 9 is set, the processing routine also advances to step ST10.

In step ST10, the time management, such as the recording time or recording end, is performed based on the set time information of the RTC 9.

As mentioned above, in the TV broadcasting receiving apparatus 1 according to the present invention, among the plurality of pieces of time information provided for the TV broadcasting receiving apparatus 1, the time of the RTC 9 is sequentially set based on the precise time information. Therefore, the time management can precisely be performed upon using the EPG, thereby certainly realizing the recording. In addition, the precise time information can externally be provided.

Even when the receiving function of the digital TV broadcasting is not provided or the reception of the digital TV broadcasting is interrupted due to a heavy rain or the like, the Internet time can be received via the Internet 33 and the time of the RTC 9 can be set by using the Internet time. Therefore, it is possible to precisely and certainly perform the programmed recording of program of the analog TV broadcasting by using the EPG provided from the ASP 34 connected to the Internet 33.

Since the time setting of the RTC 9 is automatically performed, it does not result in the operating burden of the user.

Further, since the user can select the permission or prohibition of the automatic time setting function, an arbitrary time of the RTC 9 manually-set by the user can preferentially be used and the time management is greatly flexible.

Further, even when the TOT and the Internet time are not received and the time setting of the RTC 9 is not performed, an indication is displayed for prompting a user to set the built-in timer, thereby setting the timer and keeping the time precision of the RTC 9 within a setting error range.

The present invention is not limited to the above embodiment and can be modified and embodied without the essential of the present invention. Further, the present invention can variously be formed by properly combining a plurality of components disclosed in the embodiment. Furthermore, some components may be deleted from the entire components shown in the embodiment. In addition, components according to different embodiments may properly be combined.

For example, a recording device 35 shown in FIG. 1 may be included in the structure of the TV broadcasting receiving apparatus 1. Further, all of the audio processing unit 12, the video processing unit 13, the speaker unit 14, and the video display unit 15, or one or more of them may not be included in the structure of the TV broadcasting receiving apparatus 1.

What is claimed is:

1. A TV broadcasting receiving apparatus comprising:
a digital broadcasting receiving unit that receives digital TV broadcasting;
a first time-extracting unit that extracts first time-information included in the digital TV broadcasting;
a second time-extracting unit that extracts second time-information via an electric communication line;
an electronic timer that enables a time setting; and
a control unit that sets a time of the electronic timer and performs various time management based on the time of the electronic timer,
wherein, when the first time-information is obtained, the control unit sets the time of the electronic timer by using the first time-information and, when the first time-information is not obtained and the second time-information is obtained, the control unit sets the time of the electronic timer by using the second time-information.

2. The TV broadcasting receiving apparatus according to claim 1, wherein when both of the first time-information and the second time-information are not obtained, the control unit performs various time-management based on a time of the electronic timer when the time of the electronic timer is set by a user, and displays an indication for prompting the time setting to the user when the time of the electronic timer is not set.

3. The TV broadcasting receiving apparatus according to claim 1, wherein the control unit sets the time of the electronic timer by using the first time-information, thereafter, when the first time-information is not obtained and the second time-information is obtained, the control units sets again the electronic timer by using the second time-information.

4. The TV broadcasting receiving apparatus according to claim 1, wherein only when a user sets permission of an automatic time-setting, the control unit sets the time of the electronic timer by using the obtained first time-information and second time-information.

5. The TV broadcasting receiving apparatus according to claim 4, wherein the control unit displays an indication for promoting the setting of the permission or a prohibition of the automatic time-setting to the user.

6. A receiving method of a TV broadcasting receiving apparatus, comprising:
extracting first time-information included in digital TV broadcasting;
extracting second time-information via an electric communication line;
setting a time of an electronic timer built in by using the first time-information when the first time-information is obtained;
setting a time of the electronic timer by using the second time-information when the first time-information is not obtained and the second time-information is obtained; and
performing various time-management based on the set time of the electronic timer.

7. The receiving method according to claim 6, wherein when both of the first time-information and the second time-information are not obtained, further comprising:
performing various time-management based on a time of the electronic timer when the time of the electronic timer is set by a user; and
displaying an indication for prompting the time setting to the user when the time of the electronic timer is not set.

8. The receiving method according to claim 6, wherein when the first time-information is not obtained and the second time-information is obtained after setting the time of the electronic timer by using the first time-information, further comprising:
setting again the electronic timer by using the second time-information.

9. The receiving method according to claim 6, wherein the setting the time of the electronic timer by using the first time-information or the second time-information is performed only when a user sets permission of an automatic time-setting.

10. The receiving method according to claim 9, further comprising:
displaying an indication for prompting a setting of the permission or a prohibition of the automatic time-setting to the user.
